(19) United States
(12) Patent Application Publication
(10) Pub. No.: US 2019/0326745 A1
(43) Pub. Date: Oct. 24, 2019

(54) APPARATUS FOR PROTECTING BATTERY

(71) Applicant: WESA LLC, Albany, NY (US)

(72) Inventors: Zevi KRAMER, Albany, NY (US); Shawn GROCE, Albany, NY (US)

(73) Assignee: Wesa LLC, Albany, NY (US)

(21) Appl. No.: 16/310,688

(22) PCT Filed: Jun. 15, 2017
(86) PCT No.: PCT/US2017/037696

§ 371 Date: Dec. 17, 2018

Related U.S. Application Data
(60) Provisional application No. 62/352,131, filed on Jun. 20, 2016.

(51) Int. Cl. H02H 7/18; H02H 1/00; B60R 16/033

(52) U.S. Cl. CPC H02H 7/18; B60R 16/033; H02H 1/0007

(57) ABSTRACT

A system is provided for preventing battery drain of a motorized vehicle and methods for using the same. The system may include a voltage sense module, a current sense module, a relay module and an optional overcurrent indicator module. The battery voltage sense module may sense a battery voltage and send an under-voltage signal to the relay module when the battery voltage goes below a predefined voltage threshold. The current sense module may sense a current of the load and send an overcurrent signal to the relay and the overcurrent signal to the overcurrent indicator module when a current of the load is higher than a predefined current threshold. The relay module may be configured to disconnect the power from the load upon receiving at least one of the signals. The system may advantageously be encapsulated in a smart fuse that has a standard fuse form factor.

### CROSS REFERENCE TO RELATED APPLICATIONS

This application is a Section 371 of International Application No. PCT/US2017/037696 filed Jun. 15, 2017, which was published Dec. 28, 2017 under Publication No. WO 2017/222910 A1, and which claims the benefit of provisional patent application No. 62/352,131 filed Jun. 20, 2016, both of which are incorporated herein by reference in their entirety.

### FIELD OF ENDEAVOR

Aspects of the present disclosure generally relate to electrical systems of motorized vehicles, and particularly, provide battery drain protection when a vehicle's engine is not running.

### BACKGROUND

Battery drain has been a serious issue for motorized vehicles for many years. In a typical scenario, a driver leaves an electrical accessory on while the vehicle's engine stops running. In such a scenario, the battery of the vehicle may begin to drain and may eventually not have sufficient charge to support ignition of the vehicle.

In order to address the issue, many approaches have been adopted to prevent the battery drain, which utilize additional hardware. For example, one approach uses battery power detector devices to serially connect with the battery for monitoring the battery charge. However, these approaches involve additional devices and require special installation and/or need space(s) in engine compartments of the vehicles.

U.S. Pat. No. 9,156,356 assigned to GTR Development LLC discloses an electronically controlled battery contactor that protects a battery of a vehicle from excessive current drain when the vehicle is parked, protects against short circuits across the main electrical feed, and provides emergency disconnect for vehicle impact, rollover or sensed thermal events. Based on different conditions (under-voltage or overcurrent), the battery contactor control provides protection to the battery.

U.S. Pat. No. 4,493,001 assigned to General Motors Corporation discloses a system which operates to disconnect a battery of a vehicle from the load if an abrupt battery voltage drop is sensed.

U.S. Pat. No. 4,902,956 assigned to Sloan discloses a safety device wired in series with selected accessories in a wiring circuit of a vehicle. It basically describes a safety device that determines the state of charge of the battery as a function of the rate of discharge of the battery.

Attempts have been made in the past, resulting in several devices that disconnect the battery of the vehicle when an overcurrent or under-voltage situation occurs. However, these devices are connected serially to the battery, consuming electric power, and involve installing additional components to the already completed electrical systems of the vehicles.

In view of the foregoing reasons, it may be desirable to have an apparatus and method to protect the vehicle from battery drain and not involve additional devices.

### SUMMARY OF THE DISCLOSURE

It will be understood that this disclosure is not limited to the particular systems, and methodologies described, as there can be multiple possible embodiments of the present disclosure which are not expressly illustrated in the present disclosure. It is also to be understood that the terminology used in the description is for the purpose of describing the particular versions or embodiments only, and is not intended to limit the scope of the present disclosure.

Various aspects of the present disclosure may address techniques and mechanisms for a smart fuse for preventing a battery of a motorized vehicle from being drained, e.g., when the motorized vehicle's engine is not running. The smart fuse may include a battery voltage sense module, a current sense module and a relay module. The battery voltage sense module may be configured to measure an output voltage of the battery; the current sense module may be configured to sense a current running from the battery to a load of the motorized vehicle; and the relay module may be configured to control a connection between the battery and the load based on the output voltage of the battery and the current running from the battery to the load.

According to one aspect of the disclosure, the battery voltage sense module may detect whether the output voltage is lower than a predefined voltage threshold and may send an under-voltage signal to the relay module when the output voltage is lower than the predefined voltage threshold. Additionally, the relay module may be configured to turn off the power to the load upon receiving the under-voltage signal.

According to further aspects of the disclosure, the current sense module may be configured to detect whether the current is greater than a predefined current threshold and to send an overcurrent signal to the relay module when the current is greater than the predefined current threshold. Additionally, the relay module may be configured to turn off the power to the load upon receiving the overcurrent signal.

According to further aspects of the disclosure, the smart fuse may further include an overcurrent indicator module configured to indicate that the current exceeded the predefined current threshold. According to further aspects of the disclosure, the load may include one or more electrical accessories selected from a group of electrical accessories of the motorized vehicle.

Further aspects of the present disclosure may address techniques and mechanisms of a battery protection system for a motorized vehicle, which includes a load of the motorized vehicle, a battery installed in the motorized vehicle for providing power to the load of the motorized vehicle, a relay module disposed between the battery and the load and a smart fuse for preventing the battery from being drained when the vehicle's engine is not running. The smart fuse may include a battery voltage sense module configured to measure an output voltage of the battery and a current sense module configured to sense a current running from the battery to a load of the vehicle. The relay module is configured to control a connection between the battery and the load based on the output voltage of the battery and the current running from the battery to the load.

According to some aspects of the disclosure, the battery voltage sense module may detect whether the output voltage is lower than a predefined voltage threshold and may send an under-voltage signal to the relay module when the output voltage is lower than the predefined voltage threshold. Additionally, the relay module may be configured to turn off the power to the load upon receiving the under-voltage signal.

According to further aspects of the disclosure, the current sense module may be configured to detect whether the current is greater than a predefined current threshold and to send an overcurrent signal to the relay module when the current is greater than the predefined current threshold. Additionally, the relay module may be configured to turn off the power to the load upon receiving the overcurrent signal.

According to further aspects of the disclosure, the battery protection system may further include an overcurrent indicator module configured to indicate that the current running through the smart fuse is greater than the predefined current threshold. According to further aspects of the disclosure, the load may include one or more electrical accessories selected from a group of electrical accessories of the motorized vehicle.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated that the conception and specific embodiment disclosed may be readily utilized as a basis for modifying or designing other structures for carrying out the same purposes of the present invention. It should also be realized that such equivalent constructions do not depart from the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

Various aspects of the disclosure may be embodied in the form of hardware, software, firmware, and/or combinations thereof. In the case of software or firmware, a non-transitory machine-readable medium, such as memory (e.g., but not limited to, ROM, RAM, flash, disk, etc.), may be used to store data and/or executable instructions that may be executed by one or more processing devices.

### BRIEF DESCRIPTION OF ACCOMPANYING DRAWINGS

For a more complete understanding of the present invention, reference is now made to the following descriptions taken in conjunction with the accompanying drawing, in which:

FIG. 1 shows a block diagram of an example system for preventing drainage of a vehicle battery, according to one aspect of this disclosure.

FIG. 2 shows a detail block diagram of a smart fuse related to the system of FIG. 1.

FIG. 3 shows a flowchart diagram of an example method for preventing drainage of a vehicle battery, according to a further aspect of this disclosure.

FIG. 4 shows a detail flowchart diagram of an example of the example method of FIG. 3.

It should be noted that the figures are not drawn to scale and that elements of familiar structures or functions are generally represented by like reference numerals for illustrative purpose throughout the figures. It also should be noted that the figures are only intended to facilitate the description of the various aspects of this disclosure, and therefore, do not illustrate every aspect of this disclosure and do not limit the scope of this disclosure.

### DETAILED DESCRIPTION OF ASPECTS OF THE DISCLOSURE

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

It must also be noted that as used herein and in the appended claims, the singular forms “a,” “an,” and “the” include plural references unless the context clearly dictates otherwise. Although any systems and methods similar or equivalent to those described herein can be used in the practice or testing of embodiments of the present invention, the preferred, systems and methods are now described.

Currently-available approaches for preventing a motorized vehicle from battery drain add additional devices to the already complicated electrical systems of the motorized vehicle. Furthermore, these approaches require special installation and need spaces in the vehicle's engine compartment. Because such approaches may add undesired complexity, a smart fuse for preventing battery drain, which has a similar item factor as a typical fuse, would have advantages over the currently-available approaches. This result may be achieved, according to one aspect of this disclosure, by an exemplary system 100 for preventing battery drain when the vehicle's engine is not running.

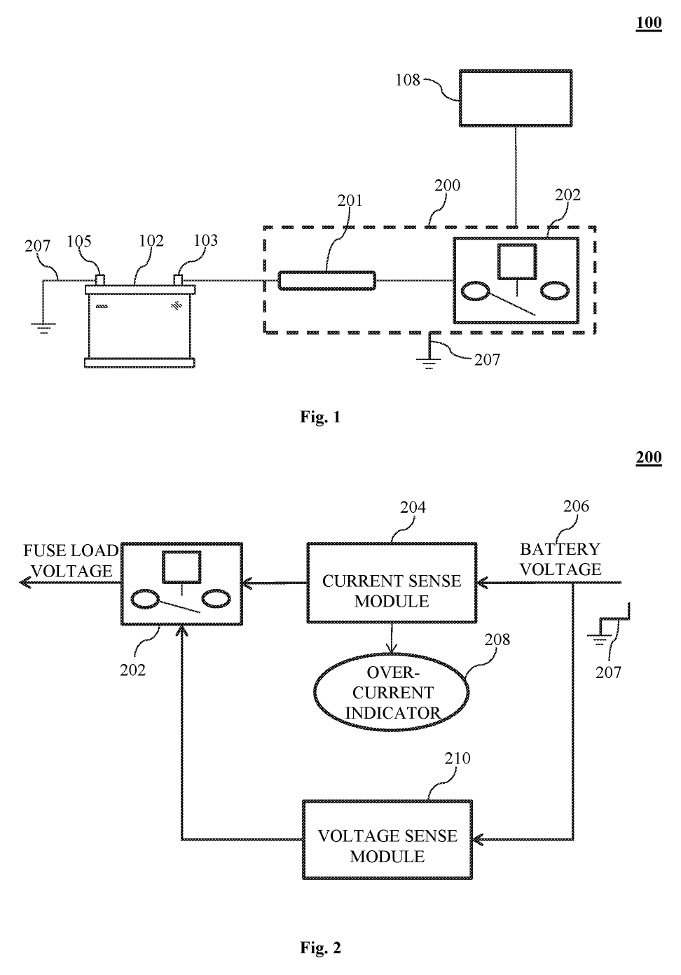

Turning to FIG. 1, the exemplary system 100 may prevent a motorized vehicle (not shown) from battery drain, particularly, when the vehicle's engine is not running. In FIG. 1, the system 100 may include a smart fuse 200 connected between a vehicle battery 102 and a load 108.

The motorized vehicle (or vehicle) may include, but is not limited to an automobile, a motorcycle, an all-terrain vehicle, farm equipment, a boat, an aircraft or the like. The load 108 may be any electrical device of the motorized vehicle, including, but not limited to, a light, a radio, a compact-disc (“CD”) player, a global positioning system, a telephone, an electrical motor, an ignition system of the vehicle, other electrical consuming devices and the like.

The vehicle battery 102 may be a rechargeable battery for supplying electric power to the load 108 of the motorized vehicle. Traditionally, the battery 102 may be known as a “starting, lighting and ignition” (“SLI”) battery. A main purpose of the battery 102 may be to start an engine of the motorized vehicle. Once the engine is up and running, power to the load 108 of the vehicle may be supplied by some other source, e.g., an alternator and/or generator that is driven by the engine. Typically, starting the engine may discharge less than three percent (<3%) of the charge capacity of the battery 102. SLI batteries may be designed to release a high burst of current in a short time, measured in amperes, and then be quickly recharged by the alternator and/or generator. Accordingly, the vehicle battery 102 may not be designed for deep discharge and, thus, a deep discharge or full discharges may reduce a lifespan of the vehicle battery 102.

According to some aspects of the present disclosure, the vehicle battery 102 may be a lead-acid type and/or may provide an output voltage of direct current. In one embodiment, the vehicle battery 102 may include a pack of six small batteries, or cells, connected in series. The vehicle battery 102 may include a positive electrode 103 (or a cathode) and a negative electrode 105 (or an anode). The negative electrode 105 may be connected to an earth 207, and the positive electrode 103 may be connected to one terminal of the smart fuse 200 that may be directly or indirectly connected to the load 108.

The smart fuse 200 may include, but is not limited to a Blade type ATM (min) fuse, an ATO (standard) fuse, an ATX (maxi) fuse, a glass type SFE fuse or the like. Different types of smart fuse 200 may have different form factors that may include, but are not limited to, different sizes, configurations and/or physical arrangements. The smart fuse 200 may include three terminals, one being connected to the positive electrode 103 of the vehicle battery 102, one being associated with a load 108 and the third one being connected to the ground 207. The smart fuse 200 may include a control element 201 and a relay 202 that may control the electric power supplied to the load 108.

According to some aspects of this disclosure, the smart fuse 200 may function as a typical fuse that may disconnect the power to the load 108, at any given time, if the current running through the fuse exceeds a predetermined specified threshold.

According to further aspects of this disclosure, the smart fuse 200 may function to prevent battery drain, particularly when the vehicle's engine is not running. The smart fuse 200 may have a functionality for sensing an output voltage of the vehicle battery 102 and/or an electric current from the vehicle battery 102 to the load 108. For example, the smart fuse 200 may include a battery voltage sense module and/or a current sense module. The battery voltage sense module may be configured for sensing the battery voltage by measuring the electrical potential difference between the positive electrode 103 of the vehicle battery 102 and the earth 207. When the voltage goes below a predefined voltage threshold then, the battery voltage sense module may send a signal to a relay module for turning off the power to the load 108. The relay module may be included or encapsulated in the smart fuse 200. The current sense module may be configured to sense a current running from the vehicle battery 102 to the load 108, and when the current is higher than a predefined current threshold, the current sense module may send a signal to the relay module to turn off the power to the load 108. Additional detail regarding the smart fuse 200 will be provided below with reference to FIG. 2.

The relay module may be an electrically operated switch or breaker that may be operated by a separated signal, e.g., the signal sent from the control element 201. The relay module may be connected between the vehicle battery 102 and the load 108 and, thereby, may be configured to disconnect or turn off the power to the load 108 when a signal is received from the control element 201. In an embodiment, when the engine of the vehicle is not running and the output voltage of the vehicle battery 102 is below the voltage threshold or the current to the load exceeds the current threshold, the control element 201 of the smart fuse 200 may send a signal to the relay module to turn off the power to the load 108 in a substantively simultaneous manner.

Unlike the conventional approaches, the proposed smart fuse 200 may advantageously be encapsulated in a typical fuse that has a standard form factor. The smart fuse 200 may turn off the power to the load module 108 when the battery voltage goes below the predefined voltage threshold or the current to the load exceeds the predefined current threshold. The smart fuse 200 may not need or require installing any additional device to the vehicle. Further, the smart fuse 200 may be configured to protect certain loads of the vehicle selected by a user. Additionally, the smart fuse 200 may not require more installation than a typical fuse and/or additional space in the engine compartment of the vehicle. The smart fuse 200 may replace a traditional fuse having a similar form factor and with additional performance. The exemplary system 100 may advantageously prevent an operator from dealing with consequences of a discharged vehicle battery and may not need additional devices added to the vehicle.

FIG. 2 shows a smart fuse 200 that is related to the exemplary system 100 for preventing battery drain when the vehicle's engine is not running. In FIG. 2, the smart fuse 200 may include a battery voltage sense module 210, a relay module 202, a current sense module 204 and an overcurrent indicator module 208.

As shown and described herein, the battery voltage sense module 210 may take a battery voltage 206 as an input. The battery voltage 206 may be an output voltage of a battery when the vehicle's engine is not running, e.g., the vehicle battery 102 (shown in FIG. 1), and may be measured based on an electrical potential difference between a positive electrode of the battery and an earth 207. In some embodiments, the battery voltage sense module 210 may be associated with the battery in a parallel manner. Additionally and/or alternatively, the battery voltage 206 may be an output voltage of an alternator and/or generator (not shown) of the vehicle when the vehicle's engine is running. In some embodiments, the alternator and/or generator may be associated with the battery 102 in a parallel manner for providing electrical power to the load 108 and/or charging the battery 102, when the vehicle's engine is running, and thus, the battery voltage 206 may be the output voltage of the alternator and/or generator.

When the battery voltage 206 goes below a predefined voltage threshold, the battery voltage sense module 210 may send an under-voltage signal to the relay module 202. In some embodiments, the under-voltage signal may be a trigger for the relay module 202 to turn off the power to a load, e.g., the load 108 (shown in FIG. 1) and, thus, the charge level of the battery may be stabilized. The predefined voltage threshold may be a voltage value selected from zero to a full-charged voltage of the battery, e.g., twelve volt selected from zero to fourteen volts, or may be defined by a percentage value of the full-charged voltage, e.g., eighty percent of the full-charged voltage.

The current sense module 204 may be associated with the battery and/or the load in a series manner and, thus, be configured to sense the current running through the load by measuring the current running through the current sense module 204. The current sense module 204 may include a current sensor for detecting the electric current running through the current sense module 204. The current sensor may be any suitable type of current sensor, e.g., a Hall effect IC sensor, a Fluxgate transformer type, a resistor type or the like. When the sensed current exceeds a predefined current threshold, the current sense module 204 may send an overcurrent signal to the relay module 202. In some embodiments, the overcurrent signal may be a trigger for the relay module 202 to turn off the power to the load and, thus, the battery may be protected from being drained.

The relay module 202 may be an electronic relay module that is an electrically operated (or controlled) switch and may be configured to disconnect or turn off the power to the load upon receiving the under-voltage and/or overcurrent signals from the voltage sense module 210 or the current sense module 204 respectively. When the relay module 202 of the smart fuse 200 is triggered to disconnect the power to the load, the relay module 202 may be resettable and may be reset in a manual manner or an automatic manner.

According to some aspects of the disclosure, the relay module 202 may be reset via a manner selected based upon whether the relay module 202 is triggered by the under-voltage signal or the overcurrent signal. In an exemplary embodiment, when the relay module 202 is triggered by the under-voltage signal, the relay module 202 may be reset automatically when the battery voltage 206 raise to a predetermined voltage threshold that may be greater than the under-voltage threshold. Additionally, when the relay module 202 is triggered by the overcurrent signal, the relay module 202 may be reset manually, e.g., by pressing a reset button on the smart fuse 200 or by unplugging and plugging the smart fusing 200. Accordingly, the relay module 202 may include two disconnect statuses: one may be used for disconnecting a circuit upon the under-voltage signal and the other one may be used for disconnecting the circuit upon the overcurrent signal.

Additionally, when the current sense module 204 detects a current running through the load exceeds the predefined current threshold, the current sense module 204 may send a signal to the overcurrent indicator module 208 that may include at least one visual and/or audible indicating element, e.g., a light-emitting diode (“LED”) indicator. The overcurrent indicator module 208 may be configured to turn on upon receiving the signal to indicate a user that the current running through the smart fuse 200 exceeds the predefined current threshold. The overcurrent indicator module 208 may be configured to turn off when the relay module 202 is reset after a triggering upon receiving the overcurrent signal.

Although shown and described as using the relay module 202 for purposes of illustration only, any suitable controllable breakers may be used to disconnect the battery from the load when the under-voltage or the overcurrent signal is received from the voltage sense module 210 or the current sense module 204.

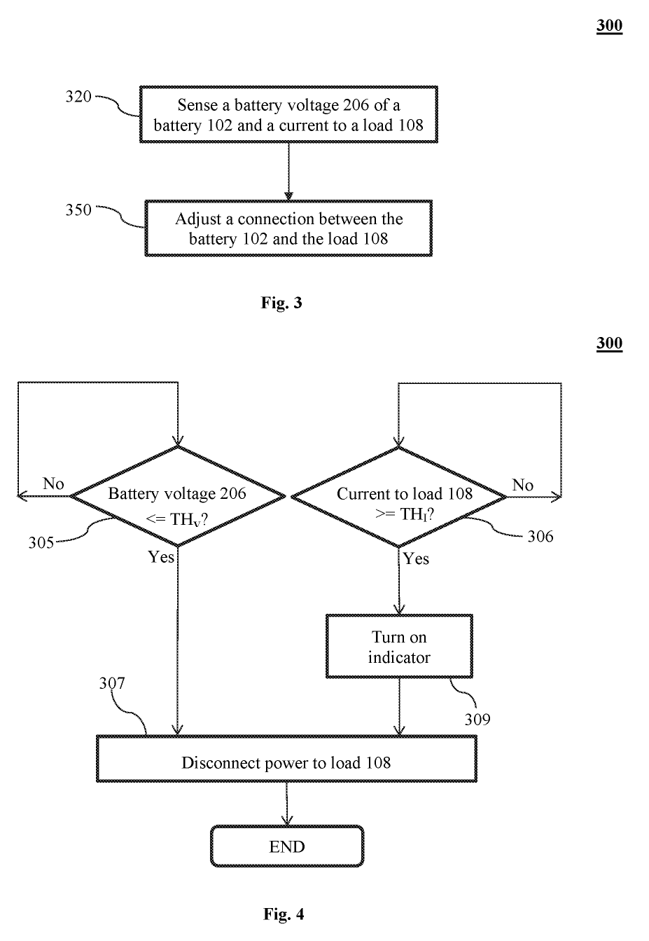

FIG. 3 shows an exemplary battery protection process 300 using the smart fuse 200 for preventing a motorized vehicle from battery drain when the vehicle's engine is not running. The battery protection process 300 of FIG. 3 may be triggered by stopping the engine of the vehicle. According to some aspects of the disclosure, the engine status may be monitored by a change of the battery voltage 206, e.g., a drop of the battery voltage 206. As described herein, when the vehicle's engine is running, an alternator and/or generator of the vehicle may provide electrical power to the vehicle and/or charge the battery 102. The battery voltage 206 may be higher when the engine is running than that when the engine is not running. For example, the battery voltage 206 may be in a proximity of twelve (12) volts when the engine is not running and may raise to fourteen and a half (14.5) volts when the engine is running and the electrical power is provided by the alternator and/or generator. Accordingly, when the battery voltage 206 is less than or equal to a predetermined voltage threshold, e.g., twelve and a half volts, the smart fuse 200 may determine that the engine of the vehicle is not running; when the battery voltage 206 is greater than the predetermine voltage threshold, the smart fuse 200 may determine that the engine is running.

When the engine of the vehicle is running, i.e., when the electrical power is provided by the alternator and/or generator, it may be not necessary to check the battery voltage 206 for a purpose of protecting the battery 102 from being drained. In such a condition, the smart fuse 200 may function as an overcurrent protection device in a manner described herein.

In FIG. 3, when engine of the motorized vehicle is running, the battery voltage 206 and/or the current to the load 108 may be sensed or monitored, at 320, periodically or continuously. The battery voltage 206 and the current may be sensed by the smart fuse 200 in a manner shown and described with reference to FIG. 2.

A connection between the battery 102 and the load 108 may be disconnected based upon a level of the battery voltage 206 and/or the current to the load 108, at 350. When the level of the battery voltage 206 is monitored to be lower than a predetermined voltage threshold, the smart fuse 200 may turn off the power from the battery 102 to the load 108. When the level of the current is monitored to be greater than a predetermined current threshold, the smart fuse 200 may turn off the power from the battery 102 to the load 108 and/or turn on an overcurrent indicator indicating the current exceeding the predetermined current threshold.

Although shown and described as being monitored by a change of the battery voltage 206 for purposes of illustration only, the status of the engine may be monitored via any other suitable manner, e.g., via monitoring a current change.

As shown and described herein, the battery protection process 300 may advantageously be performed by the smart fuse 200, saving additional devices for protecting the battery and special installations of the additional devices.

FIG. 4 shows a further example of the battery protection process 300 using a smart fuse 200. The battery protection process 300 of FIG. 4 may be triggered when the engine of a vehicle stops running and, thus the vehicle battery 102 starts providing power to electrical devices of the vehicle.

In FIG. 4, when the vehicle's engine is not running, the battery voltage 206 and the current to the load 108 may be monitored continuously via the smart fuse 200. As shown and described herein, monitoring of the voltage and/or the current may be triggered, for example, by a change of the battery voltage 206, e.g., a drop of the battery voltage 206 under a predetermined triggering voltage threshold.

The battery voltage 206 may be monitored, at 305, to determine whether a level of the battery voltage 206 becomes lower than another predetermined voltage threshold, THv. The monitoring of the battery voltage 206 may be carried out by a first functional module of the smart fuse 200. When the level of the battery voltage 206 is sensed to be lower than the predetermined voltage threshold, THv, the power from the battery 102 to the load 108 may be disconnected, at 307, to prevent a drain of the battery 102. The first functional module may include an applicable voltage meter (or voltmeter) that can be used to measure a voltage or electrical potential difference between two points, e.g., any suitable types of analogue meters, digital meters or the like. According to some aspects of this disclosure, the voltage meter may be small in size to be capsulated in the smart fuse 200. The predetermined voltage threshold, THy, may be a fixed voltage value or be a value configurable by an operator.

According to some aspects of this disclosure, the current from the battery 102 to the load 108 may sensed, at 306, to determine whether the current level becomes greater than (or exceeds) a predetermined current threshold, TH_{I}. The monitoring of the current may be carried out by a second functional module of the smart fuse 200. When the current level becomes greater than the predetermined current threshold, TH_{I}, an overcurrent indicator may be turned on to signal the current to the load 108 being over the predetermined current threshold, TH_{I}, at 309. The second functional module may include an applicable current meter that may be used to measure the current running through the smart fuse 200, e.g., any suitable types of analogue meters, digital meters or the like. The second functional module may be small in size to be capsulated in the smart fuse 200. Additionally, when the current exceeds the predetermined current threshold, TH_{I}, the power running from the battery 102 to the load 108 may be disconnected, at 307, to prevent a drain of the battery 102.

The smart fuse 200 may disconnect the power from the battery 102 to the load 108 via a third functional module of the smart fuse 200. The third functional module may include a relay, a contact, a fusible connector, any type of controllable switch or the like.

Although shown and described as turning on the overcurrent indicator before disconnecting the power to the load 108 for purposes of illustration only, turning on the overcurrent indicator and disconnecting the power may be performed in any order when the current to the load 108 exceeds the predetermined current threshold, TH_{I}.

It will finally be understood that the disclosed embodiments are presently preferred examples of how to make and use the claimed invention, and are intended to be explanatory rather than limiting of the scope of the invention as defined by the claims below. Reasonable variations and modifications of the illustrated examples in the foregoing written specification and drawings are possible without departing from the scope of the invention. It should further be understood that to the extent the term “invention” is used in the written specification, it is not to be construed as a limited term as to number of claimed or disclosed inventions or the scope of any such invention, but as a term which has long been conveniently and widely used to describe new and useful improvements in technology. The scope of the invention supported by the above disclosure should accordingly be construed within the scope of what it teaches and suggests to those skilled in the art, and within the scope of any claims that the above disclosure supports.

Various aspects of the disclosure have been presented above. However, the invention is not intended to be limited to the specific aspects presented above, which have been presented for purposes of illustration. Rather, the invention extends to functional equivalents as would be within the scope of the appended claims. Those skilled in the art, having the benefit of the teachings of this specification, may make numerous modifications without departing from the scope and spirit of the invention in its various aspects.

What is claimed is:

1. A smart fuse for preventing a battery of a motorized vehicle from being drained when the motorized vehicle's engine is not running, comprising:
a voltage sense module configured to measure an output voltage of the battery;
a current sense module configured to sense a current running from the battery to a load of the motorized vehicle; and
a relay module configured to control a connection between the battery and the load based on the output voltage of the battery and the current running from the battery to the load.

2. The smart fuse of claim 1, wherein the voltage sense module detects whether the output voltage is lower than a predefined voltage threshold,
wherein the voltage sense module sends an under-voltage signal to the relay module when the output voltage is lower than the predefined voltage threshold, and
wherein the relay module is configured to turn off the power to the load upon receiving the under-voltage signal.

3. The smart fuse of claim 1, wherein the current sense module is configured to detect whether the current is greater than a predefined current threshold,
wherein the current sense module sends an overcurrent signal to the relay module when the current is greater than the predefined current threshold, and
wherein the relay module is configured to turn off the power to the load upon receiving the overcurrent signal.

4. The smart fuse of claim 3, further comprising an overcurrent indicator module configured to indicate that the current running through the smart fuse is greater than the predefined current threshold.

5. The smart fuse of claim 1, wherein the voltage sense module is configured to determine whether the motorized vehicle's engine is running based upon a change of the output voltage of the battery.

6. The smart fuse of claim 1, wherein the load includes one or more electrical accessories selected from a group of electrical accessories of the motorized vehicle.

7. A battery protection system for a motorized vehicle, comprising:
a load of the motorized vehicle;
a battery installed in the motorized vehicle for providing power to the load of the motorized vehicle;
a relay module disposed between the battery and the load; and
a smart fuse for preventing the battery from being drained when the vehicle's engine is not running, comprising:
a voltage sense module configured to measure an output voltage of the battery; and
a current sense module configured to sense a current running from the battery to a load of the vehicle,
wherein the relay module is configured to control a connection between the battery and the load based on the output voltage of the battery and the current running from the battery to the load.

8. The battery protection system of claim 7, wherein the voltage sense module detects whether the output voltage is lower than a predefined voltage threshold,
wherein the voltage sense module sends an under-voltage signal to the relay module when the output voltage is lower than the predefined voltage threshold, and
wherein the relay module is configured to turn off the power to the load upon receiving the under-voltage signal.

9. The battery protection system of claim 7, wherein the current sense module is configured to detect whether the current is greater than a predefined current threshold,
wherein the current sense module sends an overcurrent signal to the relay module when the current is greater than the predefined current threshold, and
wherein the relay module is configured to turn off the power to the load upon receiving the overcurrent signal.

10. The battery protection system of claim 9, further comprising an overcurrent indicator module configured to indicate that the current running through the smart fuse is greater than the predefined current threshold.

11. The battery protection system of claim 7, wherein the voltage sense module is configured to determine whether the motorized vehicle's engine is running based upon a change of the output voltage of the battery.

12. The battery protection system of claim 7, wherein the load includes one or more electrical accessories selected from a group of electrical accessories of the motorized vehicle.
